(19) United States
(12) Patent Application Publication
(10) Pub. No.: US 2010/0051319 A1
(43) Pub. Date: Mar. 4, 2010

(54) CONTROLLING THE POROSITY OF METAL PASTES FOR PRESSURE FREE, LOW TEMPERATURE SINTERING PROCESS

(75) Inventors: Wolfgang SCHMITT, Rodgau (DE); Michael SCHÄFER, Kuenzell (DE); Hans-Werner HAGEDORN, Remching (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: W.C. HERAEUS GMBH, Hanau (DE)

(21) Appl. No.: 12/548,039

(22) Filed: Aug. 26, 2009

(30) Foreign Application Priority Data
Aug. 27, 2008 (DE) 10 2008 039 828.4

(51) Int. Cl. H01B 5/00; C09D 7/12; H01R 43/02

(52) U.S. Cl. 174/126.1; 106/287.18; 29/877

(57) ABSTRACT

Metal pastes and methods make it possible to produce extremely compact layers between contact surfaces of structural components, which layers are sufficiently elastic to permanently withstand mechanical and thermal stress variations. This is achieved by the porosity of a corresponding contact area being controlled. For this purpose, a metal paste is provided which contains 70-90% by weight of a metal powder, 1-20% by weight of an endothermically decomposable metal compound and 5-20% by weight of a solvent having a boiling point or range above 220° C., the metal paste being compactable exothermically to form a metal contact.

### BACKGROUND OF THE INVENTION

The present invention relates to joining technology using components, such as LED or very thin silicon chips, which are sensitive to pressure and temperature.

For bonding parts sensitive to pressure and temperature, the contact area is unsuitable with respect to thermal conductivity or electrical conductivity.

Conventional low temperature sintering cannot be used, because of the high pressure to be applied, which may exceed 200 bar. In addition, an excessively high effort would be involved, since the rate of throughput of the producing performance modules would be determined by the size of the press and a drying step would have to be carried out before actual sintering.

According to German published patent application DE 10 2007 046 901 A1 (U.S. patent application publication US 2009/0134206 A1), electrically and thermally highly conductive connecting layers can be built up for high performance electronics. Porous layers are formed at low process pressure.

### BRIEF SUMMARY OF THE INVENTION

An object of the present invention comprises producing extremely firm layers between contact surfaces, which layers are sufficiently elastic to permanently withstand mechanical and thermal stress variations and to keep the temperature and the process pressure low during compaction.

This object is achieved by controlling the porosity of the corresponding contact area. Using flakes or powders, in particular those based on silver or copper, approximately 83% of the volume can be filled, i.e., a porosity of approximately 17% remains. The optimal porosity for maximum strength of a contact depends on the material and the application conditions of the structural elements to be connected. According to the invention, the porosity of the contact area can be increased or reduced. Preferably, the porosity of the contact area is reduced, however. With the process according to the invention, it is possible not only to achieve a reduction in the porosity of the contact area, but it is additionally ensured that the porosity is uniformly low.

To control the porosity of the contact area, metal pastes, in particular silver or copper pastes, are exothermically compacted between contact surfaces. This compaction of the metal paste preferably takes place as part of a low temperature sintering process by metal produced in situ, which causes closure of gaps between the metal particles of the metal paste used. The in situ metal production takes place by decomposition of the metal compound contained in the metal paste. In order to achieve as high a compaction of the metal paste as possible, the exothermic compaction process is prolonged. This prolongation is effected by an organic solvent with a boiling point or range above 220° C. As a result of this prolongation, the metal formed in situ has more time to fill the gaps between the metal particles. In this way, a highly compact connecting layer (contact area) can be produced at a very low process pressure, which layer is very similar in terms of porosity to a silver layer produced at 200 bar from an exothermically compacted system.

The solution to the object according to the invention is provided by the features of the independent claims. The dependent claims describe preferred embodiments.

Accordingly, a metal paste is provided by the present invention which contains 70-90 percent by weight of a metal powder, 1-20 percent by weight of an endothermically decomposable metal compound and 5-20 percent by weight of a solvent with a boiling point or range above 220° C., based on the weight of the metal paste, the metal paste being compactable exothermically to form a metal contact.

Preferably, 72-88 percent by weight, more preferably 75-85 percent by weight and even more preferably 77-85 percent by weight of the metal powder, based on the weight of the metal paste, are contained in the metal paste.

The proportion of endothermically decomposable metal compound is preferably 3-18 percent by weight, more preferably 4-15 percent by weight and even more preferably 5-10 percent by weight, based on the weight of the metal paste.

The solvent with a boiling point or range above 220° C. is preferably present in the metal paste according to the invention in a quantity of 9-20 percent by weight, more preferably 10-20 percent by weight, even more preferably 11-20 percent by weight, for example 12-20 percent by weight or 14-20 percent by weight, based on the weight of the metal paste.

Apart from the metal powder, the endothermically decomposable metal compound and the solvent with a boiling point or range above 220° C., further components may be present, if necessary, in the metal paste. It may be preferable, for example, if further solvents, such as solvents with a boiling point or range below 220° C., for example, are present in the metal paste. Suitable for this purpose are, for example, terpineol, N-methyl-2-pyrrolidone, ethylene glycol, dimethyl acetamide or unbranched or branched C5-C9 alcohols. These further components may be contained in the metal paste in quantities of 0-25 percent by weight, based on the metal paste, for example. However, the possibility may also be excluded of further components being contained in the metal paste, apart from the metal powder, the endothermically decomposable metal compound and the solvent with a boiling point or range above 220° C. In particular, the possibility may be excluded of further solvents being contained in the metal paste apart from the metal powder, the endothermically decomposable metal compound and the solvent with a boiling point or range above 220° C.

Within the framework of the invention, any metal powder is, in principle, suitable as metal powder. The term “metal powder,” described as a component of the metal paste, may include, according to the invention, also mixtures of different metal powders, for example of metal powders of different composition. The metal powder used according to the invention preferably contains particles which have at least one metal, for example in elementary form, and/or at least one metal alloy. It may be preferable for the particles of the metal powder to have at least 80 percent by weight, more preferably at least 90 percent by weight, even more preferably at least 95 percent by weight, for example at least 99 percent by weight or 100 percent by weight metal and/or metal compound.

The particles of the metal powder used may have at least one metal selected from the group consisting of copper, silver, gold, nickel, palladium, platinum, and aluminum, for example.

The particles of the metal powder used may have at least one metal alloy instead of or in addition to the metals. The alloy may be a copper or noble metal compound, for example. Preferably, the alloy is an alloy commonly used in hard solders. Preferably, the alloy contains at least two metals selected from the group consisting of copper, silver, gold, nickel, palladium, platinum, and aluminum. It may be preferable for the proportion of the elements from the group of copper, silver, gold, nickel, palladium, platinum and aluminum in the alloy to amount to at least 90 percent by weight, preferably at least 95 percent by weight, such as 100 percent by weight, for example. The alloy may be an alloy of Cu/Ag, Cu/Ag/Au, Cu/Au, Ag/Au, Ag/Pd, Pt/Pd or Ni/Pd, for example. Metal powders of flakes or metal powder of particles with dimensions in the range of 0.1-10 μm, preferably 0.3-3 μm, have proved to be particularly suitable within the framework of the invention.

Basically, any endothermically decomposable metal compound can be considered suitable as the endothermically decomposable metal compound which can be used according to the invention. The term “endothermically decomposable metal compound,” described as a component of the metal paste can, according to the invention, also include mixtures of different endothermically decomposable metal compounds, e.g. of endothermically decomposable metal compounds of different composition. According to the invention, endothermically decomposable metal compound should be understood to be a metal compound whose thermal decomposition represents an endothermic process, preferably under a protective gas atmosphere. During this thermal decomposition, the liberation of metal from the metal compound ought to take place. According to a preferred embodiment, the endothermically decomposable metal compound has a metal which is also contained in the metal powder. Preferably, the endothermically decomposable metal compound has copper, silver, gold, nickel, palladium, or platinum as a metal. It may be preferable to use, as endothermically decomposable metal compounds, endothermically decomposable carbonates, lactates, formates, citrates, oxides, or fatty acid salts (e.g. those with C₆ to C₂₄ fatty acids) of the above-mentioned metals. As examples of endothermically decomposable metal compounds that can be used according to the invention, silver carbonate, silver lactate, silver formate, silver citrate, silver oxide (for example Ag₂O), copper lactate, copper stearate, copper oxide (for example Cu₂O or CuO) or gold oxides (e.g. Au₂O or AuO) can be mentioned. The endothermically decomposable metal compound contained in the metal paste preferably has a decomposition temperature below 400° C., more preferably below 350° C. and even more preferably below 300° C. Flakes or powders of particles with dimensions in the range of 0.1-10 μm, preferably 0.3-3 μm, have proved to be particularly suitable.

According to the invention, a solvent with a boiling point or range above 220° C. is contained in the metal paste. Preferably, this solvent has a boiling point or range above 250° C. According to a preferred embodiment, the solvent with a boiling point or range above 220° C. which is contained in the metal paste is an endothermically removable solvent with a boiling point or range above 220° C. According to the invention, an endothermically removable solvent should be understood to be preferably a solvent whose removal from the metal paste represents an endothermic process. This is preferably the case, for example, if the solvent is not fully reacted by the metal paste described herein, during the sintering process, thus being able to escape from the metal paste without undergoing a reaction. Within the framework of the invention, the term “solvent with a boiling point or range above 220° C.” also includes mixtures of different solvents with a boiling point or range above 220° C. The solvent with a boiling point or range above 220° C. can, for example, be 1-tridecanol, 2-tridecanol, 3-tridecanol, 4-tridecanol, 5-tridecanol, 6-tridecanol, isotridecanol, dibasic esters (e.g. dimethyl ester of glutaric, adipic or succinic acid or mixtures thereof), glycerine, diethylene glycol, triethylene glycol or mixtures thereof.

According to the invention, the metal paste is compactable exothermically to form a metal contact. This is the case if the compaction of the metal paste to form a metal contact presents itself as an exothermic process.

According to a preferred embodiment, the metal paste according to the invention is compactable exothermically without oxygen supply to form a metal contact. Without oxygen supply means according to the invention that the compaction takes place in an atmosphere free from oxygen. According to the invention, an atmosphere free from oxygen should be understood to mean an atmosphere with an oxygen content below 1%.

In addition, it is preferred for the metal paste to have a solids content of at least 50 percent by volume.

According to the invention, the metal paste may also be present in the form of a suspension. In this case, it may be preferred if, apart from the metal powder, the endothermically decomposable metal compound and the solvent with a boiling point or range above 220° C., a further solvent is contained therein. The further solvent may be a solvent with a boiling point or range below 220° C. The proportion of the further solvent is, in this case, preferably 10-50 percent by weight. The sum total of the proportions by weight of metal powder, endothermically decomposable metal compound and solvent with a boiling point or range above 220° C. is in this case preferably 50-90 percent by weight. It may be preferable if the suspension contains 70-90 percent by weight of the metal powder described herein, 1-20 percent by weight of the endothermically decomposable metal compound described herein and 5-20 percent by weight of the solvent with a boiling point or range above 220° C. described herein, based on the sum of the proportions by weight of metal powder, endothermically decomposable metal compound and solvent with a boiling point or range above 220° C., for example 50-90 percent by weight, in suspension. However, it may also be preferred if the proportion of solvent with a boiling point or range above 220° C. in the suspension is increased. In this case, the use of a solvent with a boiling point or range below 220° C. may be omitted, if necessary. According to a preferred embodiment, the suspension contains 35-81 percent by weight (preferably 50-70 percent by weight) of metal powder, 0.5-18 percent by weight (preferably 3-15 percent by weight) of endothermically decomposable metal compound, 2.5-47 percent by weight (preferably 5-10 percent by weight) of a solvent with a boiling point or range above 220° C., and 0-50 percent by weight (preferably 0-20 percent by weight) of a further solvent.

The invention provides additionally a process for joining contact surfaces placed opposite, in particular above each other, in which case the contact surfaces placed above each other are contacted with each other via the metal paste according to the invention or the suspension according to the invention and the metal paste or suspension is compacted exothermically.

Joining of the contact surfaces by exothermic compaction of the intermediate metal paste takes place according to the invention preferably via a low temperature sintering process.

The contact surfaces to be joined are preferably part of at least two structural elements to be joined.

Consequently, the invention also relates to a process for connecting at least two structural elements which are contacted with each other via the metal paste according to the invention or the suspension according to the invention, the metal paste or suspension being exothermically compacted. The structural elements to be joined are arranged on top of each other. Such an arrangement is also known as a sandwich arrangement. In particular, the structural elements to be connected should not be arranged side by side on a common carrier.

Accordingly, the use of the metal paste herein described for connecting structural elements placed on top of each other, preferably in a sandwich arrangement, to form a structural component is also provided within the framework of the invention.

Hereinafter, for reasons of better readability, the term “metal paste” is also to include a suspension.

The structural elements to be connected may be modules and/or substrates.

According to a preferred embodiment, at least two modules, at least two substrates or at least one module and at least one substrate are connected according to the invention.

As an example, the module may be an LED (light emitting diode), a die, a diode, an IGBT (insulated-gate bipolar transistor), an IC (integrated circuit), a sensor, a cooling body (e.g. aluminum cooling body or copper cooling body) or another passive structural element (a resist, condenser or coil, for example).

The substrate may be a lead frame, a ceramic substrate or a DCB (direct copper bonded) substrate.

Among preferred embodiments, the invention relates to connecting of LED with a lead frame, of LED with a ceramic substrate, of a module selected from dies, diodes, IGBT and IC with a substrate selected from lead frames, ceramic substrates or DCB substrates, of a sensor with a lead frame or a ceramic substrate, of DCB or a ceramic substrate with a copper or aluminum cooling body or of a lead frame with a cooling body. Also preferably, it is possible for the individual elements of sandwich structures to be connected with each other. As an example, such sandwich structures may have an assembly comprising (i) LED or chip, (ii) lead frame and (iii) a cooling body, the lead frame being preferably in contact with the LED or chip on the one hand and with the cooling body on the other hand via the metal paste. Moreover, the sandwich structure may comprise a structure in which a diode is present between two cooling bodies, each of the two cooling bodies being preferably connected with another contact surface of the diode via the metal paste.

Contact surface should be understood to mean according to the invention any surface of a structural element which is in contact with the metal paste according to the invention.

Individual surfaces of the structural elements to be joined, preferably the module and substrate, may comprise a metallization layer. This metallization layer may correspond to a contact surface or contain this contact surface at the surface of the metallization layer.

According to a preferred embodiment, the metallization layer may have at least one element selected from the group consisting of copper, silver, gold, palladium, or platinum. The metallization layer can also consist of these elements

On the other hand, the metallization layer may have an alloy which contains at least two elements selected from the group consisting of silver, gold, nickel, palladium and platinum. The proportion of these elements in the alloy is preferably 90 percent by weight, more preferably at least 95 percent by weight, even more preferably at least 99 percent by weight, e.g. 100 percent by weight. Preferably, such an alloy contains at least two elements selected from the group consisting of silver, palladium and platinum. The metallization layer may preferably have at least 95 percent by weight, more preferably at least 99 percent by weight and even more preferably 100 percent by weight of this alloy.

The metallization layer may also have a multilayer structure. It may thus be preferred if at least one surface of the structural elements to be joined comprises several layers, for example, which have the above-mentioned elements and/or alloys. According to a preferred embodiment, at least one surface of a structural element, e.g. a DCB substrate, comprises a copper layer onto which a layer of nickel is applied. If necessary, a layer of gold can be applied again onto the nickel layer. The thickness of the nickel layer is preferably 1-2 μm and the thickness of the gold layer is preferably 0.05-0.3 μm. On the other hand, it may also be preferred if a surface of a structural element comprises a layer of silver or gold and, on top of it, a layer of palladium or platinum. According to a further preferred embodiment, the individual layers contain, apart from the above-mentioned elements or alloys, also a glass. It may also be preferred if the layers represent a mixture of (i) glass and (ii) the elements or alloys.

In this context, it may be preferred, for example, for an LED to have a metallization layer of silver or a coating of nickel and gold, a chip to have a metallization layer of silver or a coating of nickel and gold, a lead frame to have a metallization layer of copper or silver or a coating of nickel and gold, a DCB substrate to have a metallization layer of copper or silver or a coating of nickel and gold, ceramic substrates to have a metallization layer of silver, gold, palladium, platinum, a silver-palladium alloy or a silver-platinum alloy, and a cooling body to have a metallization layer of copper, silver or a coating of nickel and gold.

Within the framework of the process according to the invention, the structural elements to be joined are brought into contact with each other via the metal paste according to the invention.

For this purpose, an assembly is produced which comprises at least two structural elements which are contacted with each other via the metal paste according to the invention. Preferably this is effected by a surface of a structural element being first of all provided with the metal paste and another structural element being placed on top by its surface onto the metal paste.

The application of the metal paste onto the surface of a structural element can take place by conventional processes, such as printing processes (screen printing or template printing), dispense technique, spray technique, by pin transfer or by dipping, for example.

Subsequently, the surface provided with the metal paste of this structural element is preferably brought into contact with a surface of the structural element to be connected, via the metal paste. Thus, a layer of metal paste is present between the structural elements to be connected. The surfaces of the structural elements which are opposite to each other and in contact with the metal paste are, according to the invention, the contact surfaces of the two structural elements.

The wet layer thickness between the structural elements to be joined, which is measured as the distance between the two contact surfaces opposite each other of the structural elements to be connected before the sintering process, is preferably in the range of 20-200 μm. The preferred wet layer thickness depends on the application process selected. If the metal paste is applied by a screen printing process, a wet layer thickness of 20-50 μm may be preferred. If the application of the metal paste takes place by template printing, the preferred wet layer thickness may be in the range of 50-200 μm.

If necessary, the assembly thus obtained is dried before the low temperature sintering process. The drying temperature is preferably in the range of 50-100° C. It goes without saying that the drying time depends on the composition and the size of the structural part. On the other hand, drying can also take place directly after the application of the metal paste onto the at least one surface of the structural element and before contacting with the structural element to be connected.

The assembly of the at least two structural elements, which are in contact with each other via the metal paste, is subsequently preferably subjected to a low temperature sintering process. During this process, the exothermic compaction, described here, of the metal paste takes place.

According to the invention, a low temperature sintering process should be understood to mean a sintering process which takes place preferably at a temperature in the range of 230-350° C., more preferably in the range of 250-300° C.

In this case, the process pressure is preferably in the range of 0-200 bar, more preferably in the range of 1-50 bar.

The sintering time depends on the process pressure and is preferably in the range of 2-45 minutes. At a process pressure of 0-2 bar, for example 0 bar, the sintering time is preferably in the range 20-45 minutes, at a process pressure of 5-15 bar, for example 10 bar, it is preferably in the range of 15-30 minutes, at a process pressure of 40-60 bar, for example 50 bar, it is preferably in the range 10-20 minutes, and at a process pressure of 180-200 bar, for example 200 bar, it is preferably in the range of 2-5 minutes.

According to the invention, the porosity of the contact areas between the structural elements to be connected can be controlled in a targeted manner. Since the structural elements have different temperature, pressure and time sensitivities, it is necessary to control the porosity via the metal paste.

This control can be achieved in particular by the proportion of the solvent with a boiling point or range above 220° C. in the metal paste used.

The higher, for example, the proportion is chosen of the solvent with a boiling point or range above 220° C. in the metal paste, the longer is the period during which the exothermic compaction process takes place in the low temperature sintering process. Consequently, more time is available for the metal produced in the metal paste during the low temperature sintering process in situ from the endothermically decomposable metal compound to fill the gaps between the metal particles of the metal paste used. This results in a reduction of the porosity of the contact area between the structural elements to be connected.

On the other hand, the porosity of the contact area can also be increased by reducing the proportion of solvent with a boiling point or range above 220° C. in the metal paste.

According to the invention, a metal paste which contains a metal powder, an endothermically decomposable metal compound and a solvent with a boiling point or range above 220° C. is therefore used to control the porosity of a contact area between structural elements to be connected in a low temperature sintering process.

Preferably, the metal paste is the metal paste described above which contains 70-90 percent by weight of a metal powder, 1-20 percent by weight of an endothermically decomposable metal compound and 5-20 percent by weight of a solvent with a boiling point or range above 220° C.

Consequently, a process for controlling the porosity of a contact side between two structural elements is made available, wherein an assembly comprising two structural elements which are connected with each other by a metal paste is subjected to a low temperature sintering process, characterised in that the metal paste comprises a metal powder, an endothermically decomposable metal compound and a solvent with a boiling point or range above 220° C., and the proportion of the solvent with a boiling point or range above 220° C. is adjusted in such a way that the desired porosity of the contact area is achieved.

By way of the process described, a structural component can be produced which comprises at least two structural elements arranged on top of each other (in particular in a sandwich structure), which elements are connected with each other by an exothermically compacted metal paste as defined above. According to the invention, the structural component thus has contact surfaces which are joined by a compacted metal paste or suspension as described above.

According to the invention, the metal of a metal paste or suspension which contains, apart from the metal powder as main component, an endothermically decomposable metal compound and an endothermically removable solvent, is compacted, the compaction being ultimately controlled by the endothermic decomposition of the metal compound.

During the production of a contact area by joining opposing metal surfaces by a contact paste which has metal particles and a decomposable compound of a metal selected from the group of silver, copper, aluminum, nickel, and palladium, the paste is preferably reacted during the decomposition of the metal compound exothermically to form a low porosity fixing mass.

The exothermic reaction of the metal compound can be controlled in terms of time by the presence of an organic solvent which has a boiling point or range above 220° C., in particular above 250° C.

The exothermic reaction can be maintained within a period of 10 seconds up to 10 minutes.

According to the invention, it is anticipated that the solvent is removed during the decomposition of the metal compound. On the other hand, the decomposition of the metal compound can take place also during the removal of the solvent.

According to the invention, the porosity of the attachment and contact layer produced, in particular based on silver or copper, is consequently reduced by metal produced in situ, in particular silver or copper, filling the gaps between the flakes or powder granules. In a further development according to the invention, the exothermic process is prolonged such that the closure of the gaps takes place continuously. This slowing down of the exothermic reaction is effected by an organic solvent which has a high boiling point or range. The use of such a solvent allows the porosity to be controlled. Solvents with a boiling point or range of up to 200° C. cannot be considered for this purpose. They evaporate too rapidly such that the exothermic reaction takes place instantly. Solvents with a boiling point or range above 220° C. allow the prolongation of the exothermic reaction to more than 10 seconds. Solvents with a boiling point or range above 250° C. allow the prolongation of the exothermic reaction to as much as 10 minutes. During this process, the slow formation of silver and the slow evaporation of the organic components cause simultaneously a considerable reduction of the pores and consequently a higher level of compaction. For this purpose, a metal paste is provided according to the invention which has 1 to 20, preferably 2 to 10 percent by weight of an endothermically decomposable metal compound, preferably a silver compound such as Ag₂CO₃, 5 to 20 percent by weight, preferably 9 to 20 percent by weight of a solvent with a boiling point or range above 220° C., preferably above 250° C., such as TDA, 0 to 10 percent by weight, of the usual auxiliary agents for silver pastes, such as terpineol, and at least 60 percent by weight of silver particles.

The main components of the paste consequently comprise metal particles, preferably silver or copper particles which are joined together to form a dense structure during the intended application. In the case of an excessively high proportion of metal particles, e.g. a weight ratio above 90% by weight of silver particles, the paste properties are lost. In the case of an insufficiently high proportion of metal particles, e.g. a proportion below 60% by weight of silver particles, an excessively high porosity of the joining area remains. To crosslink the metal particles, in particular silver particles, the endothermically decomposing metal compound, in particular the silver compound, is used in a process appearing to be exothermic in a differential thermoanalysis (DTA). The metal formed from the endothermic metal compounds, in particular silver compound, in particular silver, connects the metal particles, in particular copper or silver particles, together and fills the gaps between the metal particles, in particular the copper or silver particles. In the case of an insufficient amount of endothermic metal compound, e.g. a proportion below 1% by weight of silver compound in the paste, the pores of the joining layer cannot be sufficiently reduced and consequently the firmness cannot be achieved in the quality possible according to the invention. In the case of an excessively high proportion of the endothermic compound, e.g. a proportion above 20% by weight of silver compound, the exothermic reaction is difficult to control and there is the risk of the pores not being efficiently filled as a result of too violent a short reaction or, on the other hand, the reaction time lasts for an unduly long period making the process uneconomic for mass production. If the proportion of the high-boiling solvent is too low, in particular less than 5% by weight, the exothermic development of the reaction cannot be prolonged for a sufficiently long period such that no controlled reduction of the pores takes place. If, however, the high-boiling solvent is used as the main component, its removal is an obstacle to a satisfactory reduction of the porosity.

Suitable metal particles are flakes or powders with particle sizes in the μm range based on copper, noble metals, nickel, or aluminum and mixture thereof easily soluble in each other, such as Cu/Ag, Cu/Ag/Au, Cu/Au, Ag/Au, Ag/Pd, Pt/Pd and Ni/Pd. Silver-containing mixtures are preferably free from nickel. Entirely correspondingly, systems of particles and metal compounds are suitable if the metal liberated from the metal compound is easily soluble with the metal of the particle. Preferably, the metal liberated from the metal compound dissolves during the exothermic compaction on the metal particles without forming new phases. Compounds decomposable considerably below the melting ranges of their metals are suitable endothermically decomposable metal compounds. This applies to many noble metal compounds. In the case of copper compounds, it is necessary to note whether these are toxic or whether the toxicity is tolerable, if necessary. Preferably, the decomposition of the decomposable metal compound begins during the removal of the high boiling solvent. Decomposition temperatures below 400° C., in particular below 350° C., allow the use of organic solvents. For particularly sensitive applications in the field of semiconductor technology, metal compounds with decomposition temperatures below 300° C. are used. In the case of decomposition temperatures below 300° C., common soft solder processes are replaced.

The particles should not agglomerate during storage. For this reason, nanopowders are generally not advantageous, even though particles as small as possible are preferred. Particles having a size of 0.2-10 μm, preferably 0.3-3 μm, in particular rolled particles (flakes) with a strong surface roughness have proved suitable.

The exothermic compaction according to the invention can be carried out under protective gas, in contrast to many sintering processes. On contact with the paste, the metal surfaces of the components to be joined are not oxidized under protective gas. For this reason, reliable joining areas are created using the paste. Metallizations produced on electrical structural components using the paste under protective gas can be connected without further treatment, in particular bonded. No source of oxygen is required for exothermic compacting according to the invention.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 illustrates the principle of the invention by way of a flow chart in comparison with a known process of sintering silver pastes without silver compounds.

FIGS. 2a-2d are graphs showing the influence of a high boiling solvent on the peak width of the exothermic compaction.

### DETAILED DESCRIPTION OF THE INVENTION

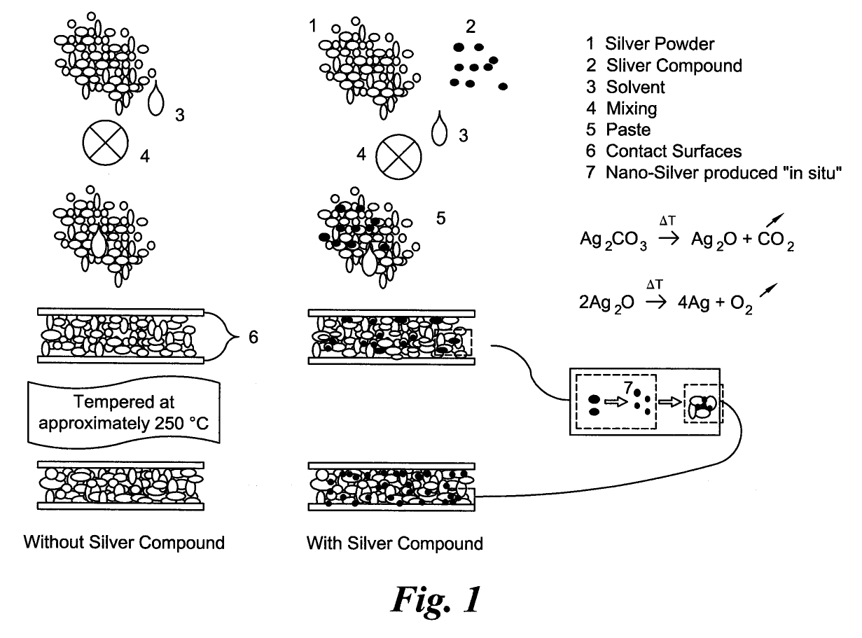

FIG. 1 illustrates compaction during which silver and silver carbonate are mixed and processed to form a paste using solvent. The silver carbonate arranged between the silver particles of the paste is decomposed without pressure at 250° C. to form reactive silver and CO₂, the reactive silver filling the gaps between the silver particles and solidifying the silver particles. In this way, a silver contact with a low porosity is produced. In an analogous manner, the silver is fixed on the substrate surface. In comparison with known silver bodies produced in the field of joining technology and having a porosity of approximately 17% by volume, the porosity can be limited to less than 10% by volume according to the invention.

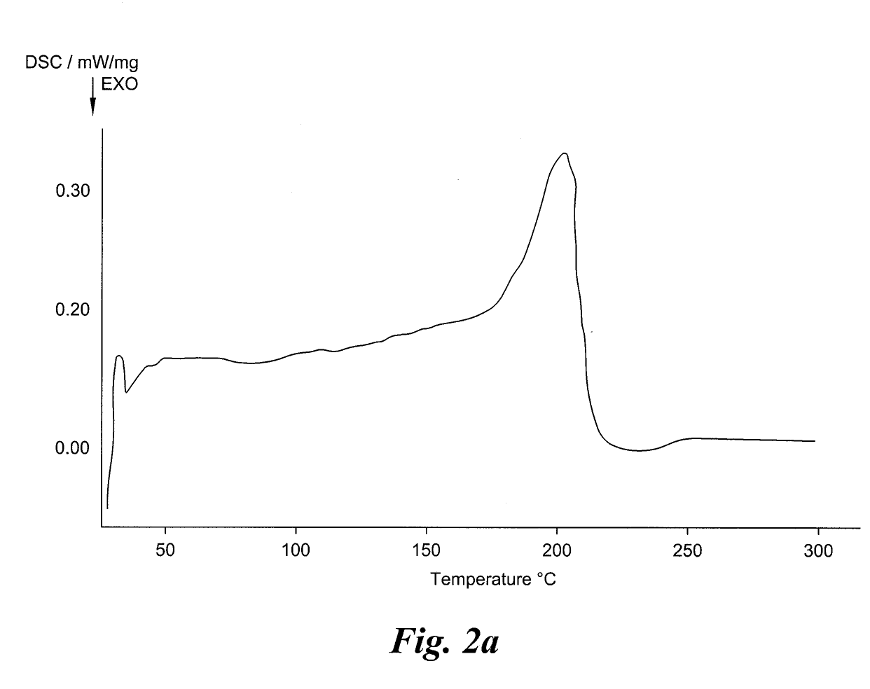

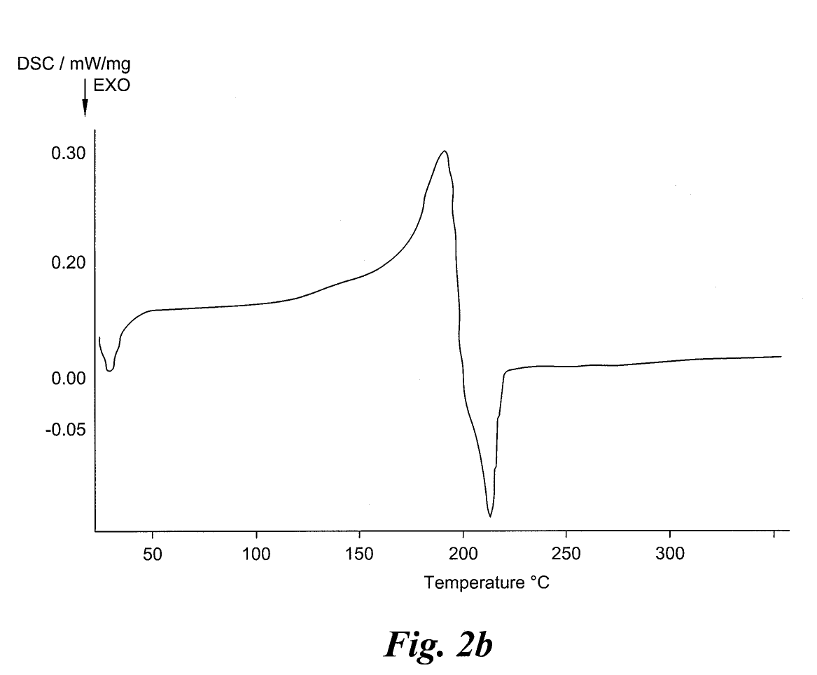

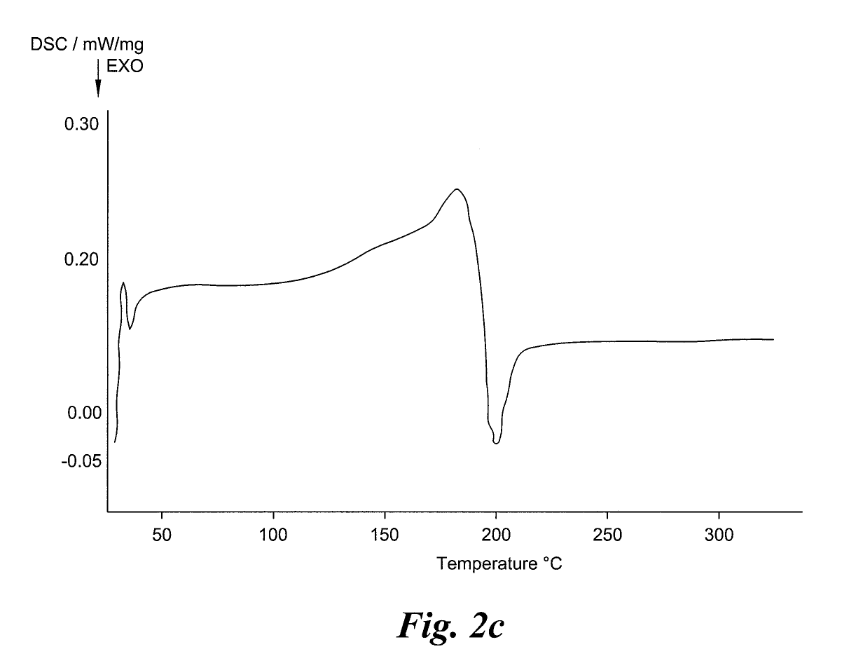

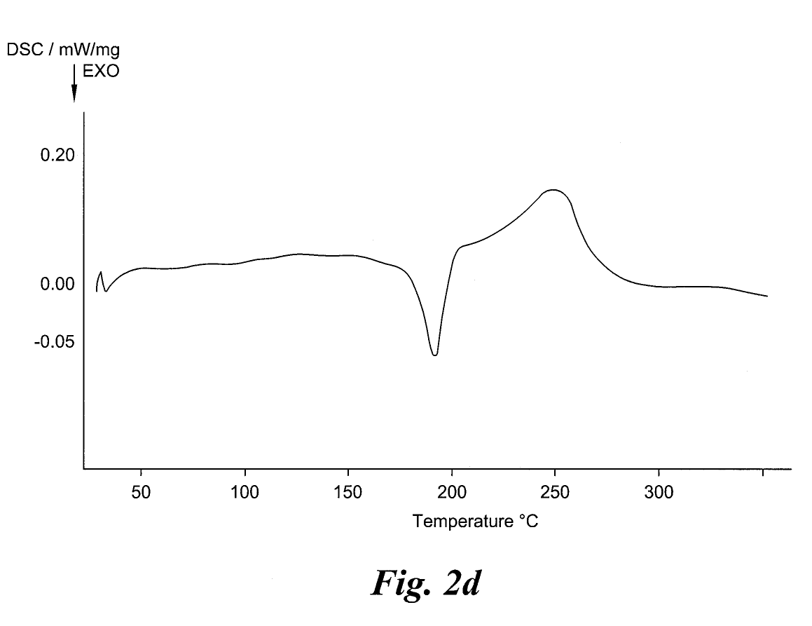

According to FIGS. 2a-2d, the duration of the exothermic compaction can be controlled by way of the proportion of high boiling solvent in the paste. Slowing down the exothermic compaction leads to a joining area with a lower pore content together with an improved mechanical, electrical and thermal conductivity.

A paste of 78 percent by weight silver, 5 percent by weight silver carbonate and 17 percent by weight terpineol (boiling point 219° C.) has an endothermic peak at 200° C. in a differential thermoanalysis carried out under protective gas according to FIG. 2a. The paste agglomerates to form a porous mass not capable of withstanding mechanical stress.

A paste of 83 percent by weight silver, 5 percent by weight silver carbonate and 12 percent by weight terpineol (boiling point or range 219° C.) has an exothermic peak after the endothermic peak at 200° C. in a differential thermoanalysis carried out under protective gas according to FIG. 2b. The paste agglomerates equally to form a porous mass not capable of withstanding mechanical stress.

A paste of 83 percent by weight silver, 5 percent by weight silver carbonate and 10 percent by weight terpineol (boiling point 219° C.) and 2 percent by weight 1-tridecanol (tridecyl alcohol or TDA; boiling range 274-280° C.) leads to peaks at 200° C. in a differential thermoanalysis carried out under protective gas according to FIG. 2c, which are displaced and clinched compared to FIG. 2b. The paste agglomerates equally to form a porous mass not capable of withstanding mechanical stress.

A paste of 83 percent by weight silver, 5 percent by weight silver carbonate and 12 percent by weight 1-tridecanol (TDA; boiling 274-280° C.) leads to an exothermic peak below 200° C. in a differential thermoanalysis carried out under protective gas according to FIG. 2d. The paste agglomerates in this case to form a mechanically firm mass with a low pore content, which withstands mechanical and thermal stress variations in high performance electronics, in particular LED attach, contacting of very small chips with up to 4×4 mm. The porosity can be controlled by varying the quantity of high boiling solvent in the paste and is consequently accurately adjustable for specific applications.

The following practical examples are to illustrate the invention:

### Example 1

A metal paste which contained 83 percent by weight of silver, 5 percent by weight of silver carbonate and 12 percent by weight of 1-tridecanol was printed onto a surface of a lead frame. Subsequently, a die with a surface area of 8 mm² was placed onto the metal paste. The wet layer thickness was 50 μm. Subsequently, the assembly thus obtained was dried for 20 minutes at 100° C. Sintering took place at a process pressure of 0 bar and a process temperature of 250° C. for a period of 45 minutes.

### Example 2

A metal paste which contained 83 percent by weight of silver, 5 percent by weight of silver carbonate and 12 percent by weight of 1-tridecanol was printed onto a surface of a lead frame using the dispense technique. Subsequently, an LED with a surface area of 9.2 mm² was placed onto the metal paste. The wet layer thickness was 50 μm. Subsequently, the assembly thus obtained was dried for 20 minutes at 100° C. Sintering took place at a process pressure of 0 bar and a process temperature of 250° C. for a period of 45 minutes.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A metal paste comprising 70-90% by weight of a metal powder, 1-20% by weight of an endothermically decomposable metal compound and 5-20% by weight of a solvent having a boiling point or range above 220° C., such that the metal paste is compactable exothermically to form a metal contact.

2. The metal paste according to claim 1, wherein the metal paste contains 11-20% by weight of the solvent with a boiling point or range above 220° C.

3. The metal paste according to claim 1, wherein the endothermically decomposable metal compound is a copper compound or noble metal compound.

4. The metal paste according to claim 1, wherein the metal powder comprises predominantly a metal selected from silver, copper, gold, palladium, and platinum.

5. The metal paste according to claim 1, wherein the metal paste is compactable exothermically without supplying oxygen to form a metal contact.

6. The metal paste according to claim 1, wherein the paste has a form of a suspension.

7. A process for joining contact surfaces placed opposite each other, comprising contacting the contact surfaces with each other via a metal paste according to claim 1, and compacting the metal paste exothermically.

8. The process according to claim 7, wherein the solvent present in the metal paste has a boiling point or range above 250° C.

9. The process according to claim 8, wherein the metal compound contained in the metal paste has a decomposition temperature below 400° C.

10. The process according to claim 8, wherein the metal compound contained in the metal paste has a decomposition temperature below 350° C.

11. The process according to claim 8, wherein the metal compound contained in the metal paste has a decomposition temperature below 300° C.

12. A structural component comprising structural elements arranged on top of each other, the structural elements being joined by a compacted metal paste according to claim 1.
